(19) United States
(12) Patent Application Publication
(10) Pub. No.: US 2012/0220907 A1
(43) Pub. Date: Aug. 30, 2012

(54) STIMULATOR

(76) Inventor: Shiri Zinn, London (GB)

(21) Appl. No.: 13/402,346

(22) Filed: Feb. 22, 2012

(30) Foreign Application Priority Data
Feb. 25, 2011 (GB) 1103323.0

(51) Int. Cl. A61H 19/00

(52) U.S. Cl. 601/46

(57) ABSTRACT

A stimulator for stimulating human female genitalia including an electrically powered vibration device and a first external massage surface for engaging the genitalia which is vibrated by the vibration device. The first massage surface includes a first surface portion surrounding a protrusion which extends above the first surface portion. The first massage surface is provided with two adjacent surfaces areas having different vibrational characteristics, a first surface area provided by the protrusion and a second surface area provided by the first surface portion surrounding the protrusion.

### CROSS-REFERENCE TO RELATED APPLICATION

This application claims priority under all applicable rules and statutes to pending United Kingdom Patent Application No. GB1103323.0 filed 25 Feb. 2011, entitled “A Stimulator,” and incorporated herein by reference in its entirety.

### FIELD

This disclosure relates to the field of stimulators. More particularly, this disclosure relates to stimulators for applying vibrations to human female genitalia.

### BACKGROUND

Stimulators, otherwise known as vibrators or massage devices, are well known. The majority of such devices are phallic shaped, for instance the devices illustrated in GB2350797, GB2366734 and U.S. Pat. No. 5,573,499. It is known also to provide a different shaped head portion for such a device, for instance in EP0684032 a tongue-shaped head is used.

Cake-shaped massage devices are disclosed in CN2136655, CN2604990, CN2269206 and CN201208385, although none are specifically designed for stimulation of human female genitalia. The hand held message devices of CN2604990 and CN2136655 are not vibrating devices, but are solid devices. The massage surfaces are smooth cambered faces with no discontinuities or protrusions. CN2269206 is a massage device which vibrates, which has a massage surface which is in part domed, but which has a flat top surface, which forms the central section of the massage surface. CN201208385 discloses a hand held massager which includes a vibrator which is capable of vibration. The massage surface has roller balls which protrude through apertures of a flat surface.

The present disclosure relates to an improved stimulator configured for stimulating human female genitalia.

### SUMMARY

The present disclosure provides a stimulator for stimulating human female genitalia including an electrically powered vibration device and a first external massage surface for engaging the genitalia which is vibrated by the vibration device.

The first massage surface includes a first surface portion surrounding a protrusion (which is preferably located centrally on the first surface portion) which extends above the first surface portion. The first massage surface is provided with two adjacent surfaces areas having different vibrational characteristics, a first surface area provided by the protrusion and a second surface area provided by the first surface portion surrounding the protrusion.

The stimulator devices according to the present disclosure provide massage surfaces which can apply vibrations in a way not provided by any of the prior art. The protrusion can provide concentrated vibration e.g. on a clitoris, whilst the surrounding dome surface applies vibration on the surrounding area of the female genitalia. This provides stimulation in a way not provided by any of the prior art devices.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a cross-section through a first preferred embodiment of stimulator according to the present disclosure;

FIG. 2 is an exploded view of the preferred embodiment of FIG. 1;

FIG. 3 is a perspective view in part cross-section of the first preferred embodiment of FIGS. 1 and 2;

FIG. 4 is a cross-sectional viewed in perspective of a second preferred embodiment of the present disclosure;

FIG. 5 is a view showing an alternative external appearance of the FIG. 1 embodiment of FIGS. 1 to 3;

FIG. 6 is a partially exploded view of a fourth preferred embodiment of stimulator according to the present disclosure;

FIG. 7 is a perspective view of the underside of a first casing component of the stimulator of FIG. 6;

FIG. 8 is a perspective view of the outside of the casing component of FIG. 7 without a protrusion shown;

FIG. 9 is a perspective view of the protrusion of the stimulator of FIG. 6;

FIG. 10 is a perspective view of the underside of the cover of the stimulator of FIG. 6; and

FIG. 11 is a perspective view of the housing of the stimulator of FIG. 6.

### DETAILED DESCRIPTION

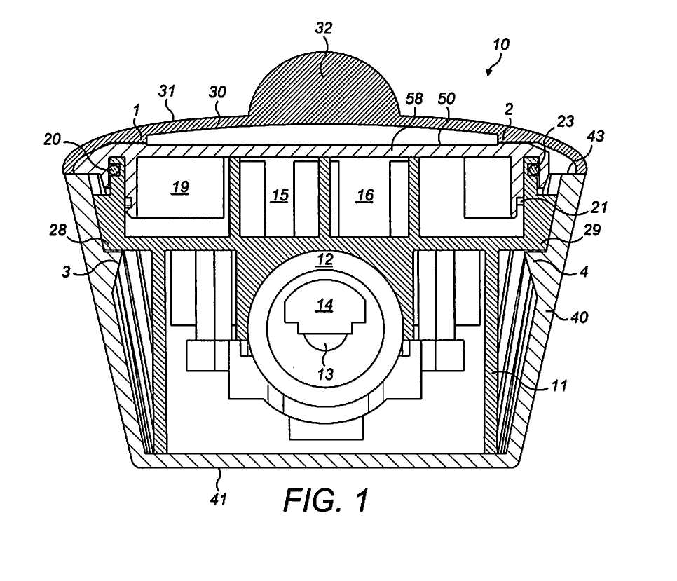

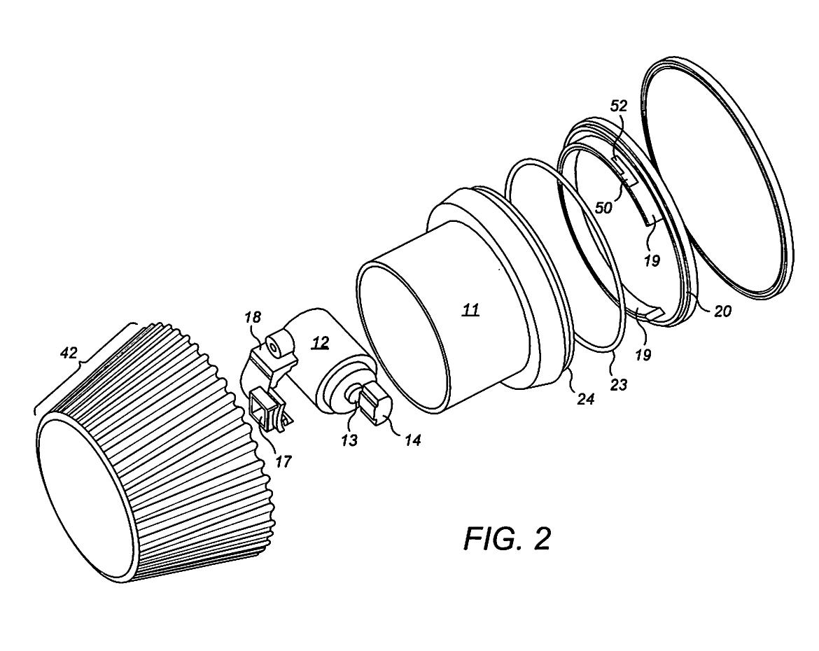

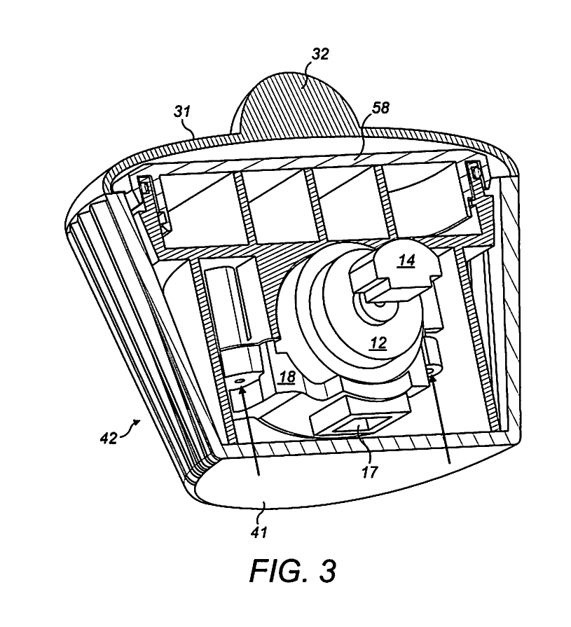

Turning first to FIG. 1, there can be seen in the Figure a stimulator 10 comprising a housing 11 which houses an electric motor 12 which has an output spindle 13 on which a weight 14 is eccentrically mounted so that when the motor rotates the spindle 13 a vibration is applied to the whole device 10. The electric motor is connected to batteries which will be located in battery compartments 15 and 16. The motor 12 will be switched on and off by a switch provided in an aperture 17 (see FIG. 2) provided in a lower part 18 of the housing 11, which will be attached by screws to the remainder of the housing 11. The lower part 18 also forms a cradle for holding the motor 12 in place within the housing 11. A cover 58 is provided for covering the battery compartments 15, 16 and this cover 58 is a removable cover. It has a flat cover plate section, from which extends an inner skirt portion 19 and an outer skirt portion 20. The outer skirt portion 20 is an annular skirt extending around the cover 18, as can be seen in FIG. 2. The inner skirt 19 is formed from two arc portions, again this can be seen in FIG. 2. The arc shaped portions 19 have grooves, e.g. the groove 50, 52 shown in FIG. 2, which are L-shaped in nature and each has a mouth 50 for receiving a tang (e.g. 21 in FIG. 1) of the housing 11 and then a slot (52 in FIG. 2) in which the tang 21 can be received on rotation of the cover 58 relative to the housing 11, in order that the cover 58 can be secured in place on the housing 11. An O-ring 23 is provided in a groove 24 provided on an external surface of the housing 11 and provides a seal between a radially inward facing surface of skirt 20 and the radially outward facing surface of the housing 11. This ensures that the battery compartments 15, 16 remain substantially water tight.

The exterior of the device is defined by two separate casing components. The first casing component 30 is secured to the cover 58 and provides a massage surface having a convex domed exterior surface 31 and a centrally located protrusion 32 which extends away from the domed surface 31 and which is surrounded by the domed surface 31. A lower cup-shaped casing component 40 is secured to the housing 11. The casing component 40 has a planar bottom section 41 and a frusto-conical wall section 42 (see FIG. 2) which is corrugated in nature, being formed of alternate ridges and grooves which extend from the flat bottom base portion 41 along the frusto-conical wall section 42 to a top annular surface 43 (see FIG. 1) of the casing component 40.

The casing component 30 is provided with shoulders 1 and 2 which provide flat surfaces abutting the flat surface of the cover 18 and allow the component 30 to be adhered to the cover 18. The component 40 has shoulders 3 and 4 which provide flat surfaces which can engage corresponding shoulders 28, 29 of the housing 11 and allow the component 40 to be adhered to the housing 11. The casing component 30 is moulded from a resilient rubber-like material such as polyvinylchloride. It is flexible and compressible. The component 40 is also made out of polyvinylchloride and again is flexible and compressible.

The wall thickness of the casing component 30 is (apart from in the region of the protrusion 32 and the region of the shoulders 1, 2) half or less than half of the wall thickness of the component 40. The thickness of the wall of the domed surface 30 will typically be between 2 and 3 millimeters. The protrusion 32 will have height of roughly 1 centimeter above the surrounding surface 31. Considering the protrusion 32 in plan view (not shown), the diameter of protrusion 32 will be between 1 and 2 centimeters.

The flat base portion 41 of the component 40 will have a diameter typically 52 millimeters, the height of the wall section 42 will be typically around 50 millimeters and the side wall section 40 will flare outwardly to a maximum of between 55 and 60 millimeters.

As shown in FIG. 1, there is a void between the central part of the casing component 30 and the cover 58. This allows the central part of the casing component 30 to flex downwardly into engagement with the cover 58 when the stimulator is applied and pressed on to a human body. However, the void 50 could be filled with a compressible material of a different compressibility to the casing component 30.

The massage surface 31 with the central domed protrusion 32 provides for stimulation of female genitalia in a way that has not been provided before by phallic shaped devices. Specifically, the massage surface provides the central protrusion 32 which will have first characteristics of contact and vibration, which is immediately surrounded by the more gently curving domed surface 31, i.e. a surface with much greater radius of curvature, which will vibrate in a different manner. The domed surface 31 will provide for an area of contact with the female genitalia which allows a significant portion of the female genitalia to be covered, vibrated and stimulated. The casing component 30 is a single integer, typically moulded and the thickness of the component 30 in the region of the domed protrusion 32 is significantly greater than the thickness of the casing component 30 elsewhere. This has the effect that more powerful vibrations are transmitted via the domed protrusion 32 than via the surrounding domed surface. Two different surface areas of contrasting sizes, shapes and vibration characteristics are therefore provided side by side.

As illustrated, the stimulator has been configured to have the external appearance of a cupcake. The applicant has realized that the provision of a domed protrusion in the centre of an overall domed massage area leads to a construction which looks like the top surface of a cupcake and therefore has configured the device as a whole to resemble a cup cake. This makes the device as a whole appealing and renders it a novelty item. Additionally, this means that the device as a whole has a shape and configuration which is comfortable to be held in the hand, with a five finger hold. The corrugated walls of the casing component 40 also provide a contrasting surface area which can be applied, if desired, to female genitalia, in order to provide a contrast in sensation compared with the smooth domed massage surface area of casing component 30.

The base portion 41 is flexible to allow depression of a section of the base portion 41 aligned with an underlying switch provided in the aperture 17, in order to allow for the electric motor to be switched on and off. Preferably a small surface depression will be provided in the base surface 41 aligned with the switch, in order to provide a visual indication to the user of where the switch is located. Alternatively surface coloration could be provided to provide such an indication.

Whilst above the casing components 30 and 40 may be made of the same material, e.g. flexible and compressible materials such as rubber or PVC, silicon or any soft flexible plastic, or hard and inflexible materials such as ABS, the casing components could be made of differing materials if wished. Also, instead of using flexible, compressible PVC, silicon or any soft plastic, each component or one of them could be made of a plastic which is substantially rigid (e.g. ABS), but which may be coated with a soft plastic layer on the outer surface thereof.

Optionally, a further layer of hard material may be provided on the outer surface of the flexible compressible material to provide a surface for printing decorative patterns (such as dots). This additional layer would be thinner than the underlying layers. The thickness may be in the region of 2 mm to 3 mm.

Dot decoration may be achieved by painting dots directly onto silicon/soft plastic material via machine application.

Whilst above the cover 58 is secured to the housing 11 and the motor 12 vibrates the stimulator as a complete entity, a variation of this is possible. In this variation the cover 58 would be allowed to translate relative to the housing 11. The electric motor 13 would be connected to a crank with a connecting arm pivotally attached to the crank and then pivotally attached to a point on the cover 58. Rotation of the electric motor would thus cause the cover 58 to translate backwards and forwards relative to the housing 11. Since the massage surface is provided on the casing component 30 attached to the cover 58 the massage surface would also be moved backwardly backwards and forwards relative to the housing 11. By a suitable choice of pivotal connection points, it is also possible to provide that the cover 58 and the surface 31 rotate relative to the housing 11 as well as translating backwards and forwards.

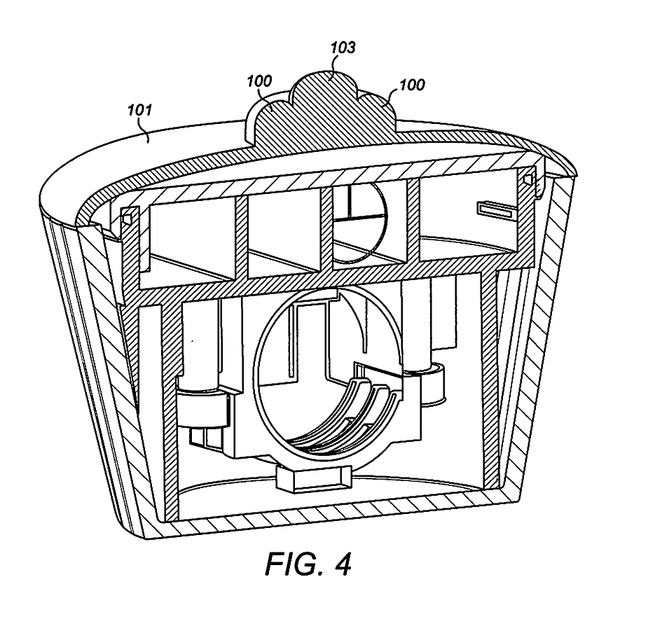

A second variant of the stimulator according to the present disclosure is illustrated in FIG. 4. This variant is identical to the first variant described above except that the protrusion is not a simple dome shape, but instead comprises external toroidal section 100 with a central dome section. The central dome section 103 has a thickness which is the greatest thickness, with the toroidal surrounding section 100 having a lesser thickness and then the wall thickness of the surrounding domed section of the casing component being less than the thicknesses of both the toroidal section 100 and the central section 103. In aesthetic appearance the protrusion will look like a flower.

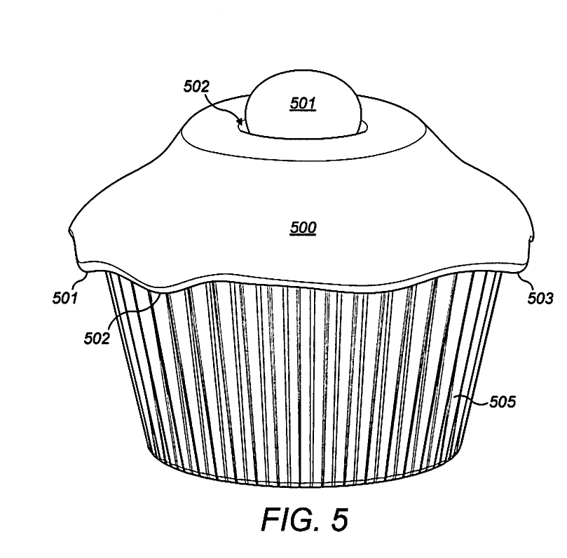

FIG. 5 shows the external appearance of a third embodiment of the disclosure. Here again there is a domed surface 500 from which extends around a centrally located domed protrusion 501 which has a radius of curvature less than half the radius of curvature of the domed surface 500. In this case the domed protrusion 501 is located in a recess 502 in the domed surface 500, in order to give an aesthetic appearance more similar to that achieved when a cherry is located in icing on top of a cupcake. The surface 500 is also provided with drip like portions 501, 502, 503, which extend downwardly from the generally annular periphery 504 of the top component 500. The embodiment illustrated in FIG. 5 provides five different surface areas for engagement female genitalia, namely: the central dome section 501; the surrounding domed area 500; the drip-like extensions 501, 502, 503 of the domed surface 500; the corrugated frusto-conical surface 505; and the flat underneath base surface (not shown). Each of the surface areas will provide a different vibratory effect, particular to that surface area of the device.

In a known manner, the electric motor 12 can be controlled to have different modes of operation and provide different speeds and intensities of vibration.

Ripple features could be formed on the generally domed surface, again to provide areas of different vibrational characteristics and also mimicking in appearance the top of a cupcake formed with an unevenly applied icing.

FIG. 6 shows a fourth embodiment of the device. This embodiment is similar to the earlier embodiments except that the first casing component 230 is manufactured in two parts. Specifically, the component forming the convex exterior surface 231 and the centrally located protrusion 232 are each separate articles.

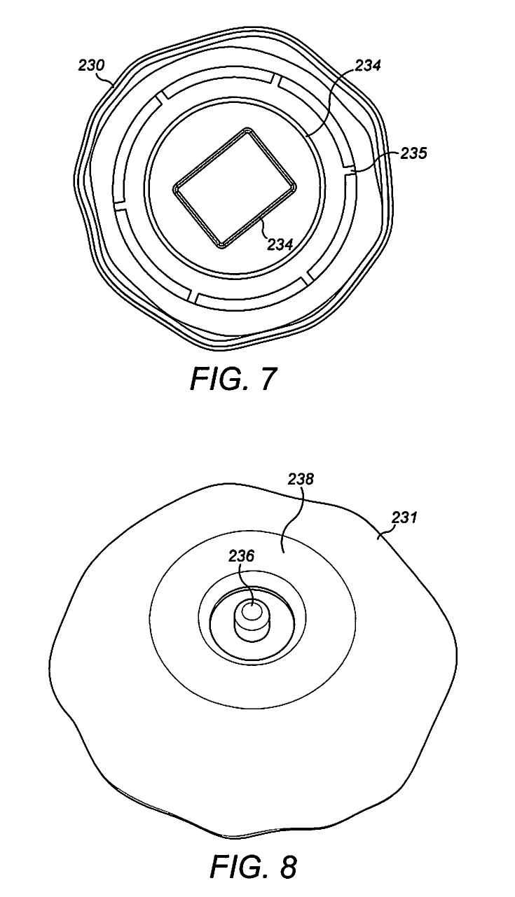

As shown in FIG. 8, an attachment member 236 is formed on the convex exterior surface 231. Attachment member 236 may be a column (preferably a generally cylindrical column), extending outwardly from the convex exterior surface 231 to which a protrusion 232 may be attached. Preferably, the attachment member 236 extends normal to the convex exterior surface 231. Preferably, attachment member 236 is located in a recess on the convex exterior surface 231.

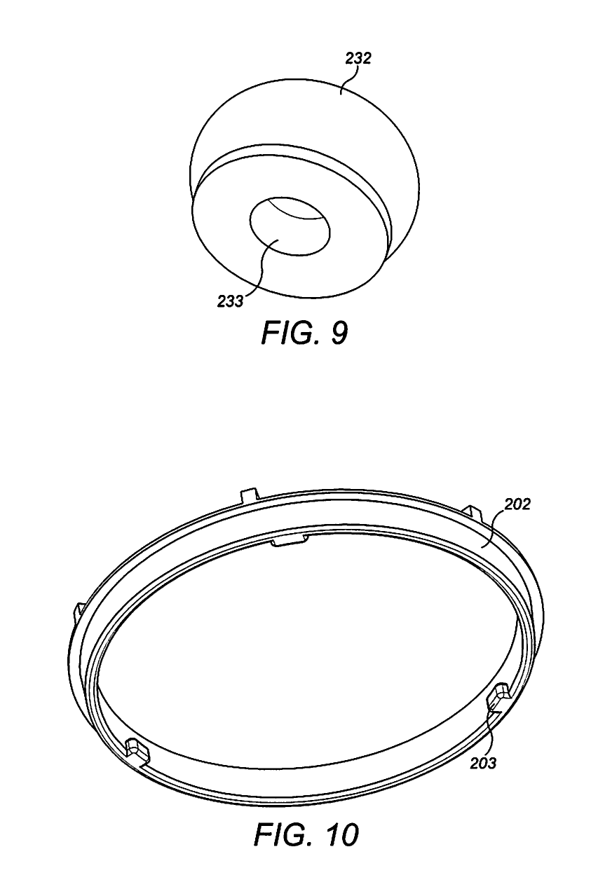

As shown in FIG. 9, the protrusion 232 may be a generally spherical or generally hemispherical solid (or a truncated sphere) having a depression or bore 233 arranged to receive the attachment member 236 to thereby prevent lateral movement of the protrusion 232 relative to the convex exterior surface 231.

The protrusion 232 is preferably glued or adhered to the component forming the convex exterior surface 231.

The convex exterior surface 231 of the fourth embodiment may be shaped as in the first embodiment.

However, optionally, and in contrast to the earlier embodiments, the convex exterior surface 231 is recessed around the attachment member 236 to provide a smooth annular ridge 238 spaced from and surrounding the protrusion 232.

As with the earlier embodiments, the casing component 230 may be moulded from a resilient rubber-like material such as polyvinylchloride.

Whilst the two components of casing 230, the protrusion 232 and the convex exterior surface 231, are made of the same material, (e.g. flexible and compressible materials such as rubber or PVC or, more preferably, hard and inflexible materials such as ABS), the casing components could be made of differing materials if wished. Also, instead of using flexible, compressible PVC each component or one of them could be made of a plastic which is substantially rigid (e.g. ABS) but which is coated with a flexible compressible material.

The casing component 230 may be solid or hollow. When hollow, the wall thickness of the casing component 230 may be half or less than half of the wall thickness of the component 40. The thickness of the wall of the casing component 230 may be between 2 and 3 millimeters. The protrusion 232 will have height of roughly 1 centimeter above the abutting surface. Considering the protrusion 232 in plan view (not shown), the diameter of protrusion 232 will be between 1 and 2 centimeters. When ridge 238 is provided, the protrusion 232 will extend approximately 0.75 cm beyond the ridge 238.

As shown in FIG. 6, the first casing component 230 is mounted on the cover 258.

Formed on the surface of the cover 258 may be ribs or flanges 256, 266 extending outwardly from a generally planar region 259. Preferably, the ribs or flanges 265, 266 extend normal to the generally planar region 259.

The ribs or flanges may form a rectangular wall 266 and/or may be an annularly shaped wall 265 as shown in FIG. 6.

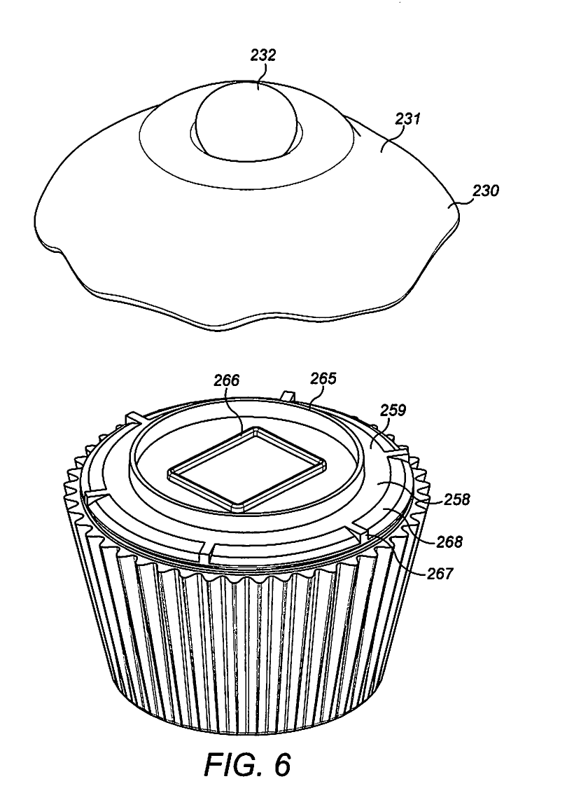

As shown in FIG. 7, the first casing component 230 may include one or more grooves 234 arranged to receive the ribs or flanges 265, 266 to thereby prevent lateral movement of the first casing component 230 relative to the cover 258.

A peripheral curved portion 268 of the cover 258 may surround the generally planar region 259. One or more spines 267 may protrude from peripheral curved portion 268 to interfit with corresponding notches 235 formed on the underside of the first casing component 230.

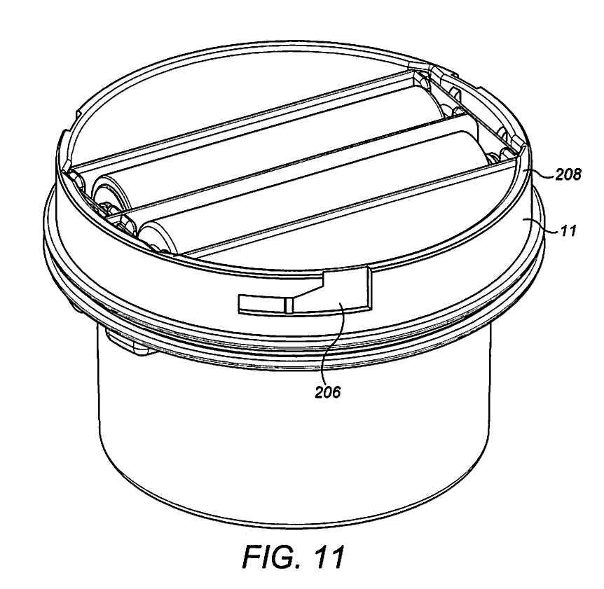

As shown in FIG. 10, protruding downwardly from the underside of the cover 258 extends annular skirt portion 202. Annular skirt portion 202 may have one or more (preferably at least three) inwardly extending tangs 203 spaced around the radially inner surface thereof. The tangs 203 may be arranged to interlock within corresponding L-shaped grooves 206 formed in the housing 11 (as shown in FIG. 11).

Preferably, the first casing component 230 is adhered to the upper surface of the cover 258, which may be attached or detached from the housing 11 by way of the tangs 203 and L-shaped grooves 206.

In the description given above, the cover 58, 258 and the lower casing component 40 may be detachably attached to each other to thereby enable replacement of the batteries. However, in alternative embodiments, the batteries may be rechargeable. In which case, a socket for a charger may be provided and the cover 30, 230 and lower casing component 40 may be permanently connected to form a seal. When the batteries require charging, this may be achieved by use of the charging socket using technology known in the art. The charging socket may be provided in the base portion 41 or, more preferably, in the side wall of the lower casing component 40.

In any of the embodiments described above, the casing component 30, 230 may be manufactured entirely from silicon. Also, the internal components of the device, such as housing 11 and cover 58, 258 may be made from ABS.

In any of the embodiments described above, the outer surface of the casing component 30, 230 may be textured. For example, the protrusion 32, 232 may be more roughly textured than the convex exterior surface 31, 231. Alternatively, the protrusion 32, 232 may be less roughly textured than the convex exterior surface 31, 231.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A stimulator for stimulating human female genitalia, the stimulator comprising: an electrically powered vibration device and a first external massage surface for engaging the genitalia which is vibrated by the vibration device, wherein the first massage surface comprises a first surface portion surrounding a protrusion which extends above the first surface portion, whereby the first massage surface is provided with two adjacent surfaces areas having different vibrational characteristics, a first surface area provided by the protrusion and a second surface area provided by the first surface portion surrounding the protrusion.

2. The stimulator of claim 1, wherein the first surface portion is dome-shaped.

3. The stimulator of claim 1, wherein the first surface portion is generally flat.

4. The stimulator of claim 1, wherein the first surface portion has a domed outer periphery.

5. The stimulator of claim 1, wherein the first surface portion has extending outwardly therefrom an attachment member to which the protrusion is attached.

6. The stimulator of claim 5, wherein the attachment member is a flange or rib extending normal to the first surface portion.

7. The stimulator of claim 1, wherein the first surface portion and the protrusion are integrally formed parts of a first casing component, the protrusion provided by a part of the first casing component with a greater thickness than a part of the first casing component forming the surrounding first surface portion.

8. The stimulator of claim 1, wherein the protrusion comprises a dome.

9. The stimulator of claim 1, wherein the protrusion comprises a central dome section surrounded by a torodial section.

10. The stimulator of claim 1, wherein the first massage surface is formed from a flexible compressible plastic material.

11. The stimulator of claim 1, further comprising a second generally frusto-conical external surface extending from a perimeter of the first external massaging surface to a base surface.

12. The stimulator of claim 1, wherein the second external surface is corrugated and provides a second massaging surface vibrated by the vibrating device.

13. The stimulator of claim 11, wherein the frusto-conical external surface and the base are integrally formed parts of a second casing component formed in a cup shape with a minimum wall thickness at least 50% greater than a wall thickness of the first portion of the first casing component.

14. The stimulator of claim 13, wherein the second casing component is formed from a flexible compressible plastic material.

15. The stimulator of claim 13, wherein the second casing component is affixed to a rigid housing located therein and the housing supports the vibration device and provides a compartment for receiving a battery for powering the vibration device.

16. The stimulator of claim 15, wherein the first casing component is affixed to a rigid cover which is releasably attachable to the housing so that the first massage component and the rigid cover can be attached to and detached from the housing and the second casing component to allow access to the battery compartment for installation and removal of a battery.

17. The stimulator of claim 15, wherein the vibration device comprises an electric motor secured to the housing and an eccentric weight driven to rotate by the electric motor to generate a vibrational force which is transmitted through the housing to the second casing component and via the housing and the cover to the second casing component.

18. The stimulator of claim 15, wherein the cover is slidable relative to the housing when attached thereto and the vibration device comprises an electric motor which is connected via a crank and a connecting rod to the cover and translates the cover relative to the housing in a reciprocating manner.

19. The stimulator of claim 18, where the electric motor additionally rotates the cover relative to the housing in a reciprocating manner.

20. The stimulator of claim 17, wherein a switch is provided to control operation of the electric motor and the switch is supported in the housing adjacent to the base surface, the base surface being flexible to allow manual depression of the switch like the base surface.

21. The stimulator of claim 16, wherein the first and second casing components together define the entirety of the external surface of the stimulator and provide the stimulator with a shape and configuration of a cup cake.

22. The stimulator of claim 1, wherein the first massage surface is provided with one or more of drop-shaped external surface portions arranged at a periphery of the first massage surface.

23. The stimulator of claim 1, further comprising one or more rechargeable batteries for powering the vibration device and means for connecting the one or more batteries to a power supply for charging.

24. A method of stimulation of human female genitalia, the method comprising the steps of: providing a vibration device having an external massage surface comprising a protrusion and a surface portion surrounding the protrusion; operating the vibration device to vibrate the protrusion at a first vibrational characteristic and the surface portion surrounding the protrusion at a second vibrational characteristic that is different from the first vibrational characteristic; and applying the massage surface to the female genitalia so that vibration is relayed thereto by both the protrusion and the surrounding surface portion.
